(19) United States
(12) Patent Application Publication
(10) Pub. No.: US 2007/0185694 A1
(43) Pub. Date: Aug. 9, 2007

(54) Method for determining strains, deformation and damage in workpieces composed of a solid material

(75) Inventors: Gilles Rousselier, Fontainebleau (FR); Sylvain Leclercq, Samoreau (FR)

Correspondence Address: SUGHRUE MION, PLLC, 2100 PENNSYLVANIA AVENUE, N.W., SUITE 800, WASHINGTON, DC, 20037, US

(73) Assignee: Electricite De France-Service National, Paris (FR)

(21) Appl. No.: 10/595,061

(22) PCT Filed: Jul. 27, 2004
(86) PCT No.: PCT/FR04/02012

§ 371 Date: Mar. 30, 2006

(30) Foreign Application Priority Data
Jul. 28, 2003 (FR) 03/09252

(51) Int. Cl. G06F 17/10

(52) U.S. Cl. 703/2

(57) ABSTRACT

The invention relates to a method for determining the effects of a mechanical force on an object consisting of a solid material, according to which the deformations and stresses caused by the mechanical force at a plurality of points on the object are determined by means of a digital calculation method in an anelastic mode wherein the behaviour of the material is represented by a polycrystalline microscopic behaviour model using a maximum of ten grain blocks, the deformations of said grain blocks being determined from a maximum of six sliding systems, and optionally a maximum of seven grain joint blocks, the deformations of said grain joint blocks being determined from at least one system and a maximum of one hole block having a variable volumic fraction, the plastic deformations of said hole block being purely volumic.

The present invention relates to a method for determining the effects of mechanical stress on an object composed of a solid material.

In numerous technical fields, it is necessary to determine the effect of mechanical stresses on workpieces, in particular metal workpieces, either in order to optimize methods of manufacture that include shaping operations, or in order to predict the behaviour in service of workpieces under complex conditions.

The shaping processes concerned are processes of shaping by plastic deformation, such as sheet-metal pressing, tube drawing, forging of machine parts. Those processes may have a considerable effect on the properties of the material constituting the workpieces concerned, and it is important to be able to predict that effect in order to enable the behaviour in service of the workpieces obtained to be estimated a priori.

The stresses on the workpieces in service are various and correspond to any of the stresses which may be encountered, for example, the effect of permanent forces, the effect of forces applied progressively at more or less high speeds, of forces applied periodically, of forces applied under conditions of ambient temperature or of forces applied under conditions of either high or very low temperature.

Numerical calculation methods, in elastic or inelastic mode, are used in known manner to estimate the effects of those mechanical stresses on workpieces. These methods of calculation are, in particular, finite difference methods and methods of the Galerkin type which are based on a decomposition on basic functions, of which a particular type is the finite element method. “Inelastic mode” means any mode of behaviour which is not reversibly elastic, that is to say, any mode of behaviour which is plastic, time-dependent plastic, or viscoplastic, temperature-dependent plastic, plastic as a result of phase transformation. These calculations use a modelling of the behaviour of the material under the effect of strains, which modelling is represented by a law linking the strains to the deformation. It is conventional to use macroscopic behaviour laws that correspond to phenomenological representations of the deformation phenomena, that is to say, representations that do not take into account the subjacent fundamental physical phenomena. Such models have the advantage of using a relatively limited number of variables, which results in calculations that are sufficiently non-voluminous to be used in industrial design processes. On the other hand, that type of model has the disadvantage of not permitting suitable modelling of the effect of the microstructure of the materials on their properties and, in particular, on the anisotropic properties, and even more particularly on the evolution of those anisotropic properties under the effect of stresses and deformation.

In order to overcome that disadvantage, it has been proposed to use material behaviour models, called “polycrystalline models”, in which the material is represented by a plurality of grains having the crystallographic structure and the properties of one grain of the material. Each grain is characterized in particular by its orientation and by the slip systems peculiar to its crystallographic structure. Under those conditions, the number of slip systems is large because it ranges from twelve for a face-centred cubic crystal to thirty for a compact hexagonal crystal. Such models have the advantage of permitting a fine representation of the behaviour of the material, but the disadvantage of requiring the use of a very large number of variables. This large number of variables leads to absolutely prohibitive calculation times which prevent such models being used in an industrial context. Finally, none of those models enables the microscopic damage to the materials to be taken into account and therefore those models do not enable rupture in service to be predicted.

The object of the present invention is to overcome those disadvantages by proposing a method for determining the effects of mechanical stress on an object composed of a solid material, which method permits fine simulation of the evolution of the properties of an anisotropic material, in particular a polycrystalline material, using a sufficiently limited number of variables for the calculation times to be reasonable and to enable simulations to be made in an industrial context, while at the same time enabling the damage to the material to be taken into account.

To that end, the invention relates to a method for determining the effects of mechanical stresses on a workpiece composed of a solid material, according to which method the deformation and strains generated by the mechanical stress at a plurality of points in the workpiece are calculated by means of a numerical calculation method in inelastic mode, in which the behaviour of the solid material is represented by a polycrystalline microscopic behaviour model using a plurality of “grain” blocks which each have an orientation and a volume fraction and whose deformation is determined on the basis of a plurality of slip systems peculiar to the solid material, the trace of the tensor of the microscopic plastic deformation of each “grain” block being zero, and the distinct orientations and the volume fractions corresponding to “grain” blocks being representative of the anisotropy of the solid material. According to the invention, the number of “grain” blocks is less than or equal to ten and the number of slip systems used in the model is less than or equal to six. In addition, the polycrystalline microscopic model may optionally use up to seven “grain boundary” blocks which each have an orientation and a volume fraction and whose deformation is determined on the basis of at least one opening system, the trace of the tensor of the microscopic plastic deformation of each “grain boundary” block being positive. The model may also optionally use a “hole” block which has a variable volume fraction and whose plastic deformation is purely in volume and whose microscopic plastic deformation tensor trace is positive.

Preferably, the six slip systems associated with a “grain” block and defined in an orthonormal coordinate system associated with the “grain” block by the normals to the slip plane and by the slip directions are such that the twin of the orientation matrix associated with each slip system is constituted only by “0”, “−1” and “1”.

For an isotropic material having a cubic structure, the deformation is determined preferably on the basis of two families of three slip systems, a first family corresponding to the faces of the crystal cube, and the second family corresponding to the planes at 45° to those faces. Preferably, the number of “grain” blocks is equal to seven and the “grain” blocks are obtained by symmetrization of symmetrical two primitive “grain” blocks located on the 45° great circles of the pole figure.

It is also possible to determine the evolution of the texture of the material by calculating the rotation Q of the crystal lattice of each “grain” block relative to a corotational coordinate system. When the material is isotropic with a cubic structure, the number of “grain” blocks is then preferably equal to ten.

It is also possible to determine the progress of a phase transformation. For that purpose, characteristics that are a function of the progress of the phase transformation may be allocated to each “grain” block.

In general, the orientations and the volume fractions of the “grain” blocks may be determined by adjustment on the basis of biaxial tension tests and tension-torsion tests.

In the absence of a “hole” block, the localization model for passing from the macroscopic level to the microscopic level for a “grain” block, which permits calculation of the tensor of the microscopic stresses σ_{g} in the “grain” block as a function of the tensor of the macroscopic stresses Σ and of the tensor ε_{g}^{P} of the microscopic plastic strains in the “grain” block and of the tensor E^{P} of the macroscopic plastic strains, is written:

$${σ}_{= g} = {Σ}_{=} + 2 μ ( 1 - β ) [ η ( {1}_{=} ⊗ {1}_{=} ) + α {1}_{{=}^{=}} ] ( {{E}_{=}}^{P} - {{ɛ}_{= g}}^{P} )$$

In that formula, α and η are two coefficients which depend, on the one hand, on the material and, on the other hand, on the maximum value reached in the course of deformation by the second von Mises invariant of macroscopic plastic deformation.

Preferably, when the calculations are finite element calculations, a single “grain” block and optionally a “hole” block or a “grain boundary” block is (are) associated with each of the integration points of the finite element calculation method; the distribution of the blocks between the integration points of the calculation method being carried out in such a manner that this distribution is homogeneous.

The finite element calculation method used may be a mechanical or thermo-mechanical calculation method involving time.

In that case, when a “hole” block is used, the volume fraction of the “hole” block is not zero at the initial instant of the calculations.

When the number of “grain boundary” blocks or “hole” blocks is greater than or equal to one, a criterion may be defined such that, when the criterion is met at one point in the object, a zero mechanical strength of the material is allocated to the point considered in order to simulate the presence of a crack.

The object of solid material is, for example, a metal workpiece subjected to a mechanical stress associated with a shaping operation by plastic deformation, in particular such as pressing, drawing, rolling, bending or forging. This list of processes of shaping by plastic deformation is not limiting.

The object may also be a metal workpiece subjected to a mechanical stress corresponding to the use of the workpiece. The use of the workpiece may especially generate phenomena of creep, fatigue, or fatigue-creep.

The method according to the invention may be used to estimate the effect of the shaping processes, such as the pressing of sheet-metal or the extrusion of a tube, on the properties of the materials. The results obtained may be used, for example, in models for simulating tests in respect of the impact resistance of motor vehicles.

The method according to the invention may also be used to simulate the manufacture of metal casings, such as cans, obtained by pressing, in order to determine the use properties thereof, taking into account phenomena such as the pressing ears resulting from the anisotropy of the material.

The method according to the invention may also be used to simulate the manufacture of nickel-alloy heat exchanger tubes for steam generators or to simulate the manufacture of zirconium-alloy fuel cladding for nuclear power stations in order better to determine the initial properties of those workpieces.

The introduction of “grain boundary” blocks and of “hole” blocks into the model enables the microscopic damage to the material to be simulated and therefore enables the rupture or the risk of rupture in service to be predicted. Therefore, the method according to the invention may also be used to study the behaviour and estimate the service life of installations. In particular in the field of nuclear power stations, in order to predict the service life of components such as reactor vessels, steam generators, pipework, fuel rod cladding, all components subjected to complex loads.

For conventional thermal power stations, the method may be used to predict the service life of equipment subjected to creep phenomena.

In aeronautics, the method may be used to predict the service life of the discs and blades of jet engines subjected to creep or fatigue-creep phenomena. Creep is the mode of damage to a workpiece subjected to a load maintained for a long period. Fatigue is the mode of damage to a workpiece subjected to a large number of successive loading cycles. Fatigue-creep is a combination of those two modes of damage, for example, when the loading cycles include maintenance for a long period under high strain.

Those uses are given only by way of example and the person skilled in the art will know how to adapt the method to any particular situation involving phenomena of plasticity or creep.

The invention will now be described in more detail with reference to the appended Figures in which:

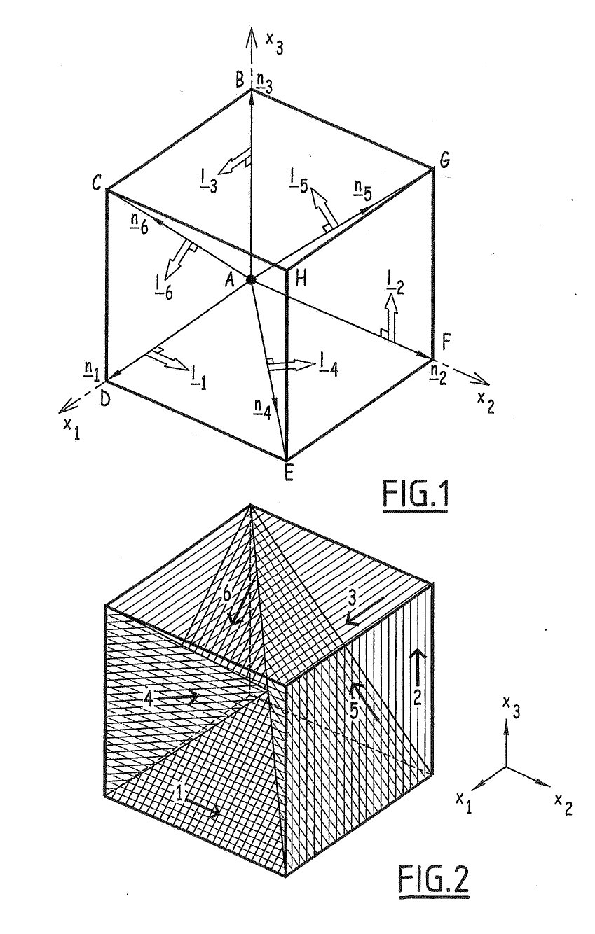

FIG. 1 shows the six slip systems used by the polycrystalline model according to the invention.

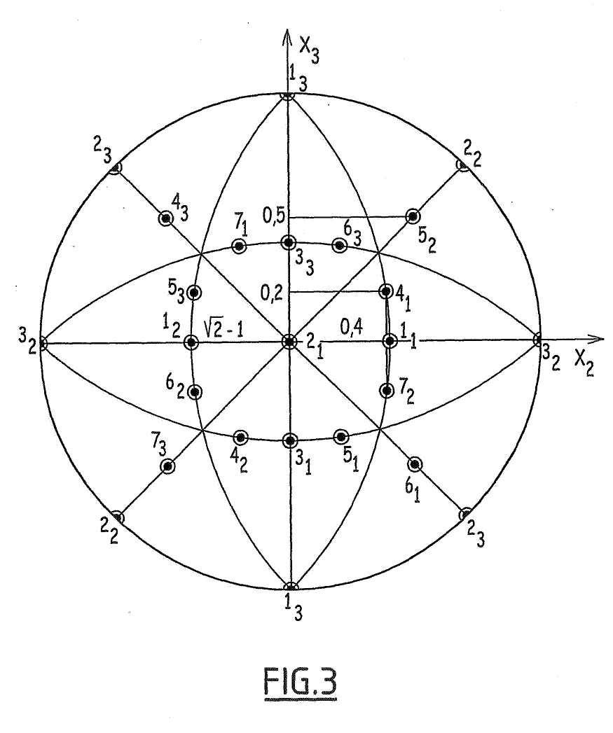

FIG. 2 shows the six slip systems used to represent the behaviour of a cubic crystal.

FIG. 3 is the pole figure of the “grain” blocks representing an isotropic material.

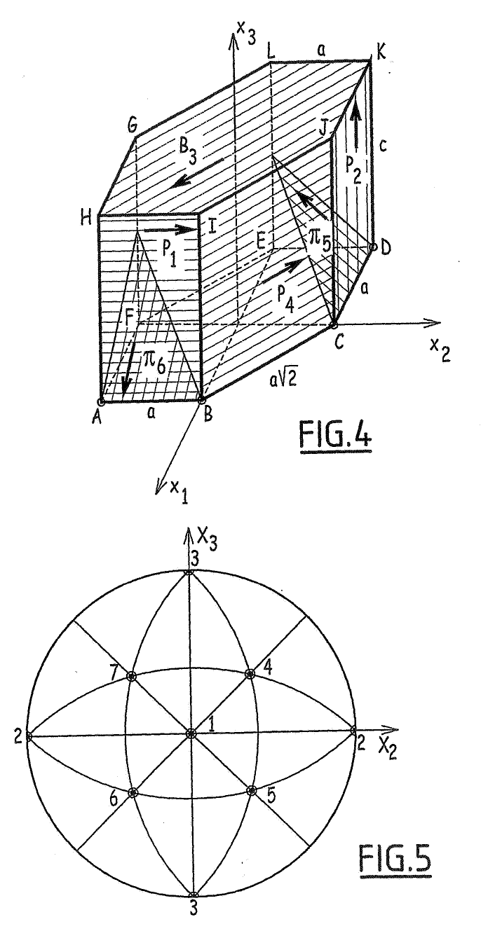

FIG. 4 shows the six slip systems used to represent the behaviour of a compact hexagonal crystal.

FIG. 5 is the pole figure of the “grain boundary” blocks of an intergranular damage model.

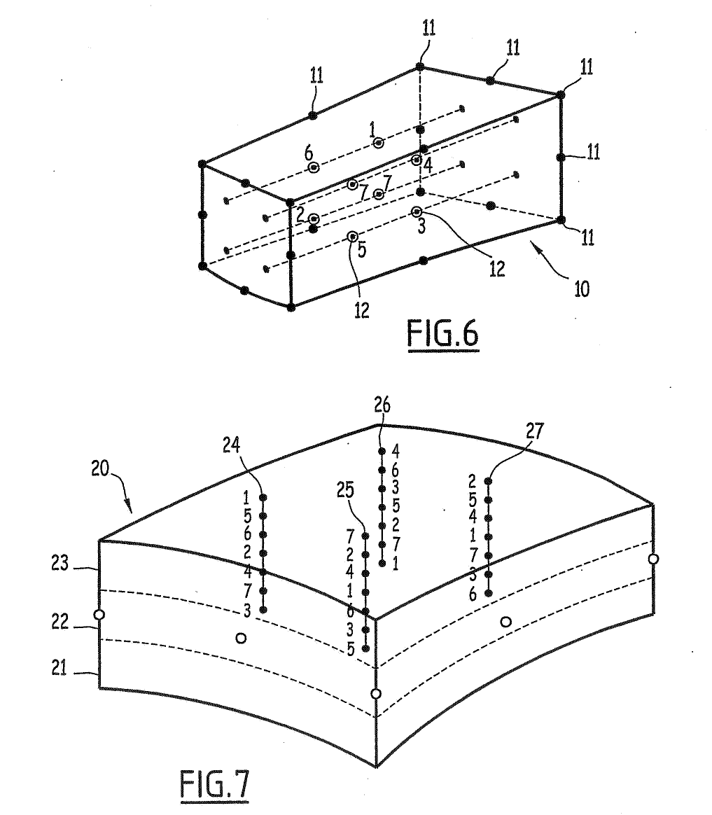

FIG. 6 shows the assignment of the blocks to the Gauss points of a finite element calculation element.

FIG. 7 shows the assignment of the blocks to the Gauss points of an element of a body.

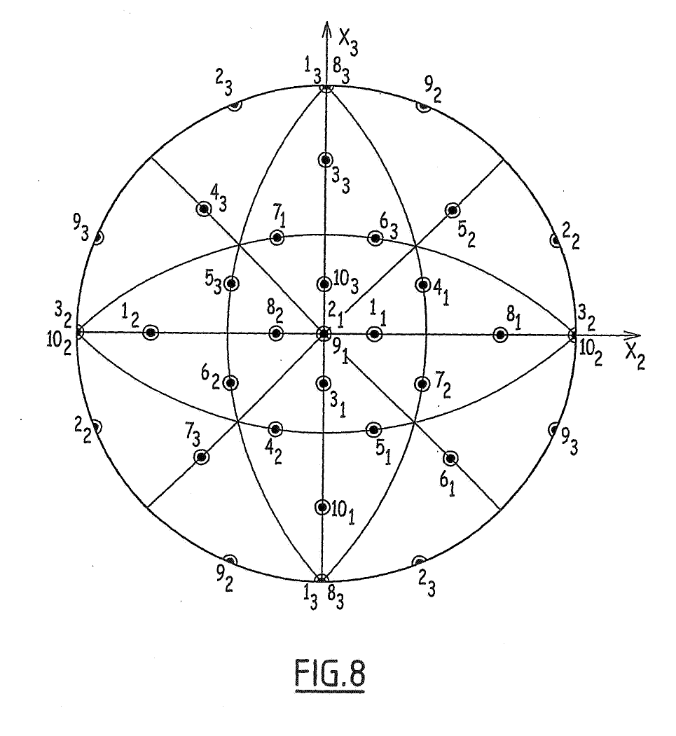

FIG. 8 is the pole figure of the “grain” blocks used to represent the texture of an initially isotropic material.

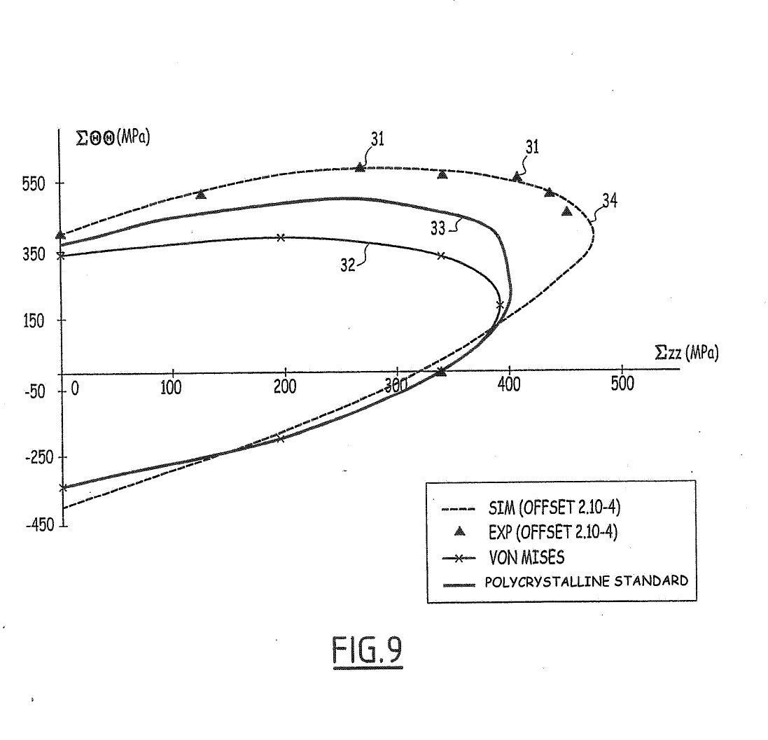

FIG. 9 shows the results of calculations corresponding to a biaxial tension test on a tube composed of recrystallized zircaloy.

While in the known polycrystalline behaviour models as many slip systems are used as there are slip systems in the real crystal, from twelve to thirty depending on the nature of the crystal, the inventors have found in a novel manner that a good representation of the deformation of a crystal can be obtained by using only six well-chosen distinct slip systems.

While the known polycrystalline models consider that it is necessary to use as many grains as there are actual orientations of the grains in the real material, the inventors have found in a novel manner that it is possible to obtain a good representation of the behaviour of the material by using a limited number of grains corresponding to at most ten different grain orientations.

The inventors have also found in a novel manner that it is possible in all cases of loading, in particular cyclic loading, and both in the case of “grain” blocks and in the case of “grain boundary” blocks, to obtain a good representation of the materials by using scale change models which make it possible to pass from the macroscopic scale to the microscopic scale and vice versa, which does not involve an additional tensor but which, instead of those tensors, uses scalar parameters.

In addition, the inventors have established in a novel manner that it is not absolutely necessary to assign all of the grains of the behaviour model to all of the calculation points, and in the case of calculation by the finite element method, to all of the integration points of the finite element method, but that it is possible to obtain excellent precision by assigning a reduced number of grains to each of the calculation points and, in the case of calculation by the finite element method, one grain to each of the calculation points of the method considered.

Finally, the inventors have found in a novel manner that it is possible to simulate damage on a microscopic scale by using simple grain boundary models which permit the simulation of intergranular damage phenomena or the use of cavity models for modelling ductile damage to the materials.

Thus, the invention is distinguished from the known numerical calculation methods by the nature of the polycrystalline material behaviour model and by the manner of incorporating it in the numerical calculation method.

In order to make the invention clearly understood, the particular case of the finite element calculation method will be considered. First of all some basic information on the techniques of calculation by that method and on the material behaviour models of the polycrystalline type will be presented, and then it will be explained how, according to the invention, a high-performance polycrystalline behaviour model is constructed and it will be indicated how that polycrystalline behaviour model is incorporated in the finite element calculation method.

Conventionally, in order to simulate by a finite element calculation the behaviour of an object subjected to mechanical stresses, a representation of the physical object considered is constructed using a lattice, and the external mechanical stresses to which it will be subjected are identified. Then, in a manner known per se, the stresses and the strains at successive instants separated by a time interval Δt are calculated by iteration. Those calculations involve a material behaviour model.

In the case of a finite element calculation using a material behaviour model of the “polycrystalline model” type, at a given instant t, there are known, for each of the cells of the lattice, the tensor of the macroscopic stresses Σ and the tensor of the macroscopic strains E, which can be decomposed into a tensor of the elastic strains E^{e} and a tensor of the plastic strains E^{P}, and, for each of the grains of the polycrystalline model, the tensor of the microscopic plastic strains ε_{g}^{P}.

Using a localization model permitting passage from the macroscopic scale to the microscopic scale, the tensor of the stresses σ_{g} in each of the grains of the polycrystalline model is determined.

Using an inelastic behaviour model, such as a plastic or viscoplastic model (such models are known per se by the person skilled in the art), and grain slip systems, the tensor of the microscopic strain rates \dot{ε}_{g}^{P} of each grain is determined.

By integrating the strain rates over an interval of time Δt, the microscopic plastic strain ε_{g}^{P} is calculated at instant t+Δt.

Using an homogenization model permitting passage from the microscopic scale to the macroscopic scale, the tensors of the macroscopic strains E and of the macroscopic stresses Σ are then determined at instant t+Δt. It is then possible to resume calculation and thus to determine the evolution over time of the stresses and strains in the object studied.

In order to implement a numerical calculation method of the type just described, three coordinate systems are used:
a global coordinate system, or laboratory coordinate system, (L₁, L₂, L₃) which is absolute and which acts as a reference for describing the object to be studied. Depending on the nature of the object studied, this coordinate system enables each point of the object to be marked by its Cartesian coordinates or by its cylindrical coordinates, or by its spherical coordinates.
orthonormal macroscopic local coordinate systems associated with each of the points of the object studied. Thus, a macroscopic local coordinate system is associated with each point and, in particular, with each point for which a calculation is made. This coordinate system is an orthonormal coordinate system whose position and orientation relative to the global coordinate system may evolve as the object studied is deformed.
orthonormal microscopic local coordinate systems which are associated with each of the “blocks” of the polycrystalline model and which are used to describe the microscopic deformation of each block. The orientation of the microscopic local coordinate system of a “block” associated with a point in the object studied represents the orientation of that grain relative to the macroscopic local coordinate system of the point considered.

Hereinafter, a macroscopic local coordinate system will be called (X₁, X₂, X₃) and a microscopic local coordinate system will be called (x₁, x₂, x₃).

The polycrystalline model used in the invention will now be described.

According to the invention, in order to construct the polycrystalline model, elemental blocks of three different kinds are used:
“grain” blocks which represent the behaviour of crystal grains;
“grain boundary” blocks which represent the behaviour of grain boundaries;
“hole” blocks which represent cavities.

The “grain” blocks enable the material to be represented in the absence of microscopic damage. The “grain boundary” blocks enable damage of the intergranular type to be represented. The “hole” blocks enable damage of the ductile type to be represented.

A description will now be given first of the “grain” blocks, then of the “grain boundary” blocks and finally of the “hole” blocks.

Slip systems, material behaviour laws for each of the slip systems, an orientation of the “grain” block relative to a coordinate system associated with the object to be studied, and finally a volume fraction f are associated in known manner with each “grain” block which is the equivalent of the “grains” used in the known polycrystalline models.

According to the invention, and irrespective of the crystallographic nature of the solid material considered, six slip systems are allocated to the “grain” block. In known manner, each system is defined by the normal to a slip plane and by a slip direction, and this enables an orientation matrix to be associated with each slip system. In an orthonormal microscopic local coordinate system (x₁, x₂, x₃) associated with the “grain” block, according to the invention, the slip systems are chosen in such a manner that the twins of the matrices of orientation mₛ of the slip systems are constituted only by 0, 1, −1.

If nₛ is the vector normal to the plane of the slip system of index s, and lₛ is the vector of the slip direction of that slip system, there results by definition:
2mₛ=(nₛ\textcircled{x}lₛ+lₛ\textcircled{x}nₛ)

With those definitions, the slip systems, represented in FIG. 1, are the following:

$$\begin{matrix}s = 1 \\ {\underline{n}}_{s} = ( \begin{matrix}1 & 0 & 0\end{matrix} ) \\ {\underline{l}}_{s} = ( \begin{matrix}0 & 1 & 0\end{matrix} )\end{matrix}$$

$$2 {m}_{= s} = \vert \begin{matrix}0 & 1 & 0 \\ 1 & 0 & 0 \\ 0 & 0 & 0\end{matrix} \vert$$

$$\begin{matrix}s = 2 \\ {\underline{n}}_{s} = ( \begin{matrix}0 & 1 & 0\end{matrix} ) \\ {\underline{l}}_{s} = ( \begin{matrix}0 & 0 & 1\end{matrix} )\end{matrix}$$

$$2 {m}_{= s} = \vert \begin{matrix}0 & 0 & 0 \\ 0 & 0 & 1 \\ 0 & 1 & 0\end{matrix} \vert$$

$$\begin{matrix}s = 3 \\ {\underline{n}}_{s} = ( \begin{matrix}0 & 0 & 1\end{matrix} ) \\ {\underline{l}}_{s} = ( \begin{matrix}1 & 0 & 0\end{matrix} )\end{matrix}$$

$$2 {m}_{= s} = \vert \begin{matrix}0 & 0 & 1 \\ 0 & 0 & 0 \\ 1 & 0 & 0\end{matrix} \vert$$

$$\begin{matrix}s = 4 \\ {\underline{n}}_{s} = ( \begin{matrix}1 / \sqrt{2} & 1 / \sqrt{2} & 0\end{matrix} ) \\ {\underline{l}}_{s} = ( \begin{matrix}- 1 / \sqrt{2} & 1 / \sqrt{2} & 0\end{matrix} )\end{matrix}$$

$$2 {m}_{= s} = \vert \begin{matrix}- 1 & 0 & 0 \\ 0 & 1 & 0 \\ 0 & 0 & 0\end{matrix} \vert$$

$$\begin{matrix}s = 5 \\ {\underline{n}}_{s} = ( \begin{matrix}0 & 1 / \sqrt{2} & 1 / \sqrt{2}\end{matrix} ) \\ {\underline{l}}_{s} = ( \begin{matrix}0 & - 1 / \sqrt{2} & 1 / \sqrt{2}\end{matrix} )\end{matrix}$$

$$2 {m}_{= s} = \vert \begin{matrix}0 & 0 & 0 \\ 0 & - 1 & 0 \\ 0 & 0 & 1\end{matrix} \vert$$

$$\begin{matrix}s = 6 \\ {\underline{n}}_{s} = ( \begin{matrix}1 / \sqrt{2} & 0 & 1 / \sqrt{2}\end{matrix} ) \\ {\underline{l}}_{s} = ( \begin{matrix}1 / \sqrt{2} & 0 & - 1 / \sqrt{2}\end{matrix} )\end{matrix}$$

$$2 {m}_{= s} = \vert \begin{matrix}1 & 0 & 0 \\ 0 & 0 & 0 \\ 0 & 0 & - 1\end{matrix} \vert$$

In FIG. 1, a cube ABCDEFGH has been shown in the microscopic local coordinate system (x₁, x₂, x₃).

The slip system s=1 corresponds to a slip in accordance with the vector l₁, parallel with the axis x₂, in a plane such as the plane CDEH which is perpendicular to the vector n₁ and parallel with the plane (x₂, x₃).

The slip systems s=2 and s=3 are comparable to the system s=1 and correspond to slips parallel with the axes x₃ and x₁, along planes parallel with the planes (x₃, x₁) and (x₁, x₂), respectively.

The slip system s=4 corresponds to a slip in accordance with the vector l₄ parallel with the diagonal DF of the square ADEF located in the plane (x₁, x₂), the slip being effected in a plane such as the plane DFGC perpendicular to the vector n₄. That plane is parallel with the axis x₃ and forms an angle of 45° with the planes (x₁, x₃) and (x₂, x₃).

The slip systems s=5 and s=6 are comparable to the system s=4 and correspond to slips parallel with the diagonals FB and BD, along the planes FBCE and BDEG, respectively. Those planes are parallel with the axes x₁ and x₂, respectively, and form angles of 45° with the planes (x₂, x₁) and (x₃, x₁) in the case of the one, and with the planes (x₁, x₂) and (x₃, x₂) in the case of the other.

With such slip systems, if \dot{γ}_{S} represents the slip rate in the direction lₛ of the slip system s, the tensor of the plastic strain rates of the “grain” block is written:

$${{ɛ}^{{\cdot }^{P}}}_{=} = {Σ}_{s} ( {{m}_{=}}_{s} {\dot{γ}}_{S} ) = \frac{1}{2} ( \begin{matrix}{\dot{γ}}_{6} - {\dot{γ}}_{4} & {\dot{γ}}_{1} & {\dot{γ}}_{3} \\ {\dot{γ}}_{1} & {\dot{γ}}_{4} - {\dot{γ}}_{5} & {\dot{γ}}_{2} \\ {\dot{γ}}_{3} & {\dot{γ}}_{2} & {\dot{γ}}_{5} - {\dot{γ}}_{6}\end{matrix} )$$

In order to determine the slip rates \dot{γ}_{S} on each of the slip systems s, a behaviour model is used which employs the classical viscoplasticity relationships which are described, for example, in La Revue Européenne des éléments finis (The European Journal of Finite Elements) Vol 3—n^{o} 4/1994, pages 515 to 541. Utilisation de modèles polycristallins pour le calcul par éléments finis. (Use of polycrystalline models for finite element calculation) Georges Cailletaud—Philippe Pilvin, and which involve in known manner the resolved scission τₛ on the system s. The resolved scission τₛ being written:
τₛ=σ_{g}:mₛ

In that equation, σ_{g} is the tensor of the strains in the grain considered.

In order to model the behaviour of a given material, it is then necessary to choose “grain” blocks of the polycrystalline model in such a manner that those blocks represent, on the one hand, the behaviour of one grain of the material, taking into account its real crystallographic nature, and, on the other hand, the behaviour of an aggregate of such grains, taking into account the real distribution of the orientations of the grains in the material, that is to say, the texture of the material.

In order to make that choice, there is associated with each slip system a critical scission such that the “grain” block obtained has a behaviour identical to that of the real crystal of which the material is composed, then the number of “grain” blocks, their orientations and their volume fractions are chosen in such a manner that the aggregate obtained has a behaviour very representative of the real material.

In order to represent the orientation of the grains, a macroscopic local coordinate system (X₁, X₂, X₃) and a microscopic local coordinate system (x₁, x₂, x₃) associated with each “grain” block are considered. The orientation of a “grain” block is defined as being the orientation of its microscopic local coordinate system (x₁, x₂, x₃) relative to the macroscopic local coordinate system (X₁, X₂, X₃).

In a manner known per se, it is considered that the microscopic local coordinate system (x₁, x₂, x₃) is derived from the macroscopic local coordinate system (X₁, X₂, X₃) by three rotations:
a rotation of angle ψ of the coordinate system (X₁, X₂, X₃) about the axis X₃ which leads to a coordinate system (X′₁, X′₂, X₃),
a rotation of angle φ about the axis X′₁ which leads to a coordinate system (X′₁, X″₂, X′₃)
a rotation of angle φ of the coordinate system (X′₁, X″₂, X′₃) about the axis X′₃ which leads to a coordinate system (X″₁, X′″₂, X′₃); this last coordinate system is the microscopic local coordinate system (x₁, x₂, x₃).

The microscopic local coordinate system (x₁, x₂, x₃) is therefore defined by the three angles of rotation Ψ, φ, φ which have enabled it to be obtained. Those angles are usually called “Euler angles”.

This methodology for choosing the “grain” blocks will be illustrated by two examples which the person skilled in the art will know how to transfer to any particular case.

The first example concerns the case of an isotropic material composed of crystals having a body-centred or face-centred cubic structure, such as the steels.

When the material is composed of crystals having a cubic structure, the slip systems may be grouped into two sub-families each corresponding to a critical scission. These two families of slip systems correspond, on the one hand, to the slips on the faces of the cube and, on the other hand, to the slips on the planes at 45° to those faces.

These six slip systems suitable for a cubic crystal are represented in FIG. 2. The systems s=1, s=2 and s=3 correspond to the slips on the faces of the cube and correspond to the same critical scission since, apart from the orientation, those faces are identical. The systems s=4, s=5 and s=6 correspond to the slips on the planes at 45° relative to the three directions of the edges of the cube. These three systems correspond to the same critical scission since, apart from the orientation, those planes are identical.

In order to produce a good representation of the isotropic character of the material, a model composed of seven grain blocks whose orientations are chosen in such a manner as best to cover a sphere is considered.

Therefore, 7 “grain” blocks chosen in such a manner that the corresponding pole figure is symmetrical are used.

For that purpose, a first group of three “grain” blocks and a second group of four “grain” blocks are constructed by proceeding as follows:
for the first group, a first primitive “grain” block of index g=1, obtained by a rotation of angle Ψ=π/4 about the axis X₃, is considered. In order to obtain identical behaviour along the three axes, the pole figure is rendered symmetrical by adding two “grain” blocks of index g=2 and g=3 obtained by rotation of π/4 about the axes X₁ and X₂, respectively. The pole coordinates of those grains are therefore 0, ±1, ±1/\sqrt{2} and ±(\sqrt{2}−1).
for the second group, a second primitive “grain” block whose poles are located on three great circles passing through one of the axes Xi and forming an angle of 45° with the other two axes, and whose coordinates are ±0,2, ±0,4 and ±0,5, is considered. Then the pole figure is rendered symmetrical by adding three “grain” blocks whose poles are derived from the poles of the second primitive “grain” block by symmetry relative to the axes X₁, X₂ and X₃.

Seven “grain” blocks are thus obtained to which the volume fraction f= 1/7 is allocated and whose angles Ψ, φ, and φ, expressed in radians, are:

| | grains: | | | | | | |
|---|---|---|---|---|---|---|---|
| | 1 | 2 | 3 | 4 | 5 | 6 | 7 |
| Ψ | π/4 | 0 | π/2 | 0.464 | π/4 | 2.034 | −2.678 |
| φ | 0 | π/4 | π/4 | 0.841 | 1.231 | 0.841 | 0.841 |
| Φ | 0 | 0 | −π/2 | 0.464 | −π/4 | −1.107 | 2.034 |

The directions of two of the three axes x1, x2 and x3 may be reversed and the three axes may be subjected to a circular permutation without modifying the results of the model. The angles of the Table correspond to a particular choice of the directions of the axes and the permutation.

The pole figure obtained is represented in FIG. 3. In that Figure, the poles marked 11, 12, 13 represent the poles of the first “grain” block. The poles marked 21, 22, 23 represent the poles of the second “grain” block and so on. It can be seen, in particular, that the poles 43, 52, 61 and 73 have as coordinates (±0,5; ±0,5). The poles 41, 42, 51, 53, 62, 63, 71 and 72 have as coordinates (±0,2 or ±0,4).

This model is universal for isotropic materials having a body-centred or face-centred cubic structure.

As a second example, an anisotropic material having a compact hexagonal structure will be considered. Such a material is, for example, recrystallized zircaloy. For such a hexagonal crystallographic structure, three groups of slip systems corresponding to three distinct critical scissions are considered. The first group resembles systems 2 and 3 which correspond to basal slip, the second group resembles systems 1 and 4 which correspond to prismatic slip, and the third group resembles systems 5 and 6 which correspond to pyramidal slips.

The slip systems that are to represent a compact hexagonal crystal are represented in FIG. 4. In that Figure, the axes x₁, x₂, x₃ constitute the orthogonal reference coordinate system of the “grain” block, that is to say, the microscopic local coordinate system. The prism having a hexagonal base A B C D E F G H I J K L is a structure which, in the context of the model, has a behaviour identical to that of a hexagonal crystal, but does not have the same geometry as that of a crystal having a hexagonal structure. The slip systems:
s=2 marked P₂ in the Figure, and s=3 marked B₃ correspond to basal slip; a first critical scission value is allocated to them;
s=1 marked P, and s=4 marked P₄ correspond to prismatic slip; a second critical scission value or two distinct values is (are) allocated to them.
s=5 marked π₅ and s=6 marked π₆ correspond to pyramidal slips; a particular critical scission value is allocated to them.

Furthermore, it is necessary to choose a specific number of “grain” blocks having orientations permitting the representation of the overall anisotropy of the material. In the second example, which concerns, in particular, a tube composed of recrystallized zircaloy, the invention uses six “grain” blocks each having a volume fraction of ⅙ whose orientations relative to the macroscopic local coordinate system (X₁, X₂, X₃) associated with the point in the object considered are the following:

g =

| | 1 | 2 | 3 | 4 | 5 | 6 |
|---|---|---|---|---|---|---|
| Ψ | 0 | π/2 | Ψ₁ | π − Ψ₁ | Ψ₂ | π − Ψ₂ |
| φ | π/2 | π/2 | π/2 | π/2 | π/2 | π/2 |
| Φ | Φ₁ | Φ₂ | Φ₃ | Φ₃ | 0 | 0 |

The orientations of those six grains depend on five parameters which correspond to five Euler angles Ψ₁, Ψ₂, φ₁, φ₂ and φ₃. Those five parameters may be determined by a numerical identification method by comparing the numerical calculation results with results of tension-torsion tests. These numerical identification methods are methods known by the person skilled in the art.

In order to model the evolution of the texture of a polycrystalline material, that is to say, the evolution of the orientations of the grains, the rotation Q of the crystal lattice of a grain is considered in known manner relative to a so-called “corotational” coordinate system. The rate of rotation of the crystal lattice is given by:

$$\dot{{Q}_{=}} : {{Q}_{=}}^{T} = - {\sum }_{s = 1}^{N} {q}_{= s} {\dot{γ}}_{s}$$

where the rotation tensor appears:
qₛ=(lₛ\textcircled{x}nₛ−nₛ\textcircled{x}lₛ)/2

The corotational coordinate system follows the mean rotation of the material R. In known manner, its rate of rotation relative to the laboratory coordinate system (L1, L2, L3) is calculated from the gradients of the speeds v of the physical points of the deformable solid body:
\dot{R}:R^{T}=(gradv−grad^{T}v)/2

In the example of the initially isotropic material composed of 7 “grain” blocks, it may be advantageous for some workpiece geometries and some particular loads, such as the rolling of a piece of sheet-metal, to maintain an orthotropic symmetry after evolution of the texture. For that purpose and in a novel manner, grains 1 to 3, obtained by rotation of π/4 about the three axes X3, X1 and X2 of the macroscopic local coordinate system, are dissociated to form six grains obtained by rotations of π/8 (grains 1 to 3) and 3π/8 (grains 8 to 10) about those axes. In addition, the axes x2 and x3 of the microscopic scale coordinate system of grain 8 are reversed, the axes x1 and x3 of grain 9 are reversed and the axes x1 and x2 of grain 10 are reversed, which is equivalent to rotations of angle π about the axes x1, x2 and x3, respectively, for grains 8, 9 and 10. There are thus obtained ten “grain” blocks whose Euler angles ψ, φ and φ and volume fractions f are:

| | grains | | | | | | | | | |
|---|---|---|---|---|---|---|---|---|---|---|
| | 1 | 2 | 3 | 4 | 5 | 6 | 7 | 8 | 9 | 10 |
| Ψ | π/8 | 0 | π/2 | 0.464 | π/4 | 2.034 | −2.678 | 3π/8 | 0 | π/2 |
| φ | 0 | π/8 | π/8 | 0.841 | 1,231 | 0.841 | 0.841 | π | 11π/8 | 3π/8 |
| Φ | 0 | 0 | −π/2 | 0.464 | −π/4 | −1.107 | 2.034 | 0 | 71 | π/2 |
| f | 1/14 | 1/14 | 1/14 | 1/7 | 1/7 | 1/7 | 1/7 | 1/14 | 1/14 | 1/14 |

The pole figure obtained in the initial state, before texture evolution, is represented in FIG. 8. In order to obtain an orthotropic pole figure after texture evolution, the ten “grain” blocks 1 to 10 may be completed by ten “grain” blocks obtained by substituting the ones for the others the normals to the slip planes nₛ and the slip directions lₛ of the 6 slip systems, which amounts to preserving the tensors of orientation mₛ, and to reversing the tensors of rotation qₛ.

The “grain boundary” blocks that are to model the intergranular damage associated with the opening of the grain boundaries will now be described.

In order to model the intergranular damage, “grain boundary” blocks are used whose behaviour is represented by at least one opening system and optionally at least one slip system.

An opening system is distinguished from a slip system by the fact that it leads to a plastic deformation tensor whose trace is positive.

As in the case of the “grain” blocks, the opening or slip systems are defined by matrices of orientation mₛ derived from the normals to the deformation planes (slip or opening) nₛ and the directions of deformation lₛ.

By way of example, the following two cases will be considered:

1) the “grain boundary” block comprises one opening system (s=1) and two intergranular slip systems (s=2 and s=3). These systems are defined in the following manner:

$$s = \begin{matrix}1 & 2 & 3\end{matrix}$$

$${\underline{n}}_{s} = \begin{matrix}( \begin{matrix}1 & 0 & 0\end{matrix} ) & ( \begin{matrix}1 & 0 & 0\end{matrix} ) & ( \begin{matrix}1 & 0 & 0\end{matrix} )\end{matrix}$$

$${\underline{l}}_{s} = \begin{matrix}( \begin{matrix}1 & 0 & 0\end{matrix} ) & ( \begin{matrix}0 & 1 & 0\end{matrix} ) & ( \begin{matrix}0 & 0 & 1\end{matrix} )\end{matrix}$$

$$2 {{m}_{=}}_{s} = ( \begin{matrix}2 & 0 & 0 \\ 0 & 0 & 0 \\ 0 & 0 & 0\end{matrix} ) ( \begin{matrix}0 & 1 & 0 \\ 1 & 0 & 0 \\ 0 & 0 & 0\end{matrix} ) ( \begin{matrix}0 & 0 & 1 \\ 0 & 0 & 0 \\ 1 & 0 & 0\end{matrix} )$$

2) The “grain boundary” block comprises three opening systems (s=1, s=2, s=3) and three intergranular slip systems (s=4, s=5, s=6):

$$s = \begin{matrix}1 & 2 & 3\end{matrix}$$

$${\underline{n}}_{s} = \begin{matrix}( \begin{matrix}1 & 0 & 0\end{matrix} ) & ( \begin{matrix}0 & 1 & 0\end{matrix} ) & ( \begin{matrix}0 & 0 & 1\end{matrix} )\end{matrix}$$

$${\underline{l}}_{s} = \begin{matrix}( \begin{matrix}1 & 0 & 0\end{matrix} ) & ( \begin{matrix}0 & 1 & 0\end{matrix} ) & ( \begin{matrix}0 & 0 & 1\end{matrix} )\end{matrix}$$

$$2 {{m}_{=}}_{s} = ( \begin{matrix}2 & 0 & 0 \\ 0 & 0 & 0 \\ 0 & 0 & 0\end{matrix} ) ( \begin{matrix}0 & 0 & 0 \\ 0 & 2 & 0 \\ 0 & 0 & 0\end{matrix} ) ( \begin{matrix}0 & 0 & 0 \\ 0 & 0 & 0 \\ 0 & 0 & 2\end{matrix} )$$

$$s = \begin{matrix}4 & 5 & 6\end{matrix}$$

$${\underline{n}}_{s} = \begin{matrix}( \begin{matrix}1 & 0 & 0\end{matrix} ) & ( \begin{matrix}0 & 1 & 0\end{matrix} ) & ( \begin{matrix}0 & 0 & 1\end{matrix} )\end{matrix}$$

$${\underline{l}}_{s} = \begin{matrix}( \begin{matrix}0 & 1 / \sqrt{2} & 1 / \sqrt{2}\end{matrix} ) & ( \begin{matrix}1 / \sqrt{2} & 0 & 1 / \sqrt{2}\end{matrix} ) & ( \begin{matrix}1 / \sqrt{2} & 1 / \sqrt{2} & 0\end{matrix} )\end{matrix}$$

$$2 {{m}_{=}}_{s} = ( \begin{matrix}0 & 1 / \sqrt{2} & 1 / \sqrt{2} \\ 1 / \sqrt{2} & 0 & 0 \\ 1 / \sqrt{2} & 0 & 0\end{matrix} ) ( \begin{matrix}0 & 1 / \sqrt{2} & 0 \\ 1 / \sqrt{2} & 0 & 1 / \sqrt{2} \\ 0 & 1 / \sqrt{2} & 0\end{matrix} ) ( \begin{matrix}0 & 0 & 1 / \sqrt{2} \\ 0 & 0 & 1 / \sqrt{2} \\ 1 / \sqrt{2} & 1 / \sqrt{2} & 0\end{matrix} )$$

The choice of the “grain boundary” blocks depends on the nature of the stresses to which the object whose behaviour it is desired to study is subjected.

When the object whose behaviour it is desired to study is subjected to stresses in a single direction, X1, a single “grain boundary” block perpendicular to the direction X1 may be considered whose opening system corresponds to the direction X1 and whose other two slip systems correspond to X2 and X3.

For a load in any direction, it is possible either to use three “grain boundary” blocks perpendicular to each of the directions X1, X2, X3, or to use a single “grain boundary” block comprising three opening systems and three slip systems.

Finally, for the fine description of damage by multiaxial stress, seven “grain boundary” blocks may be considered, each having one opening system and two slip systems, and an orientation defined by the two Euler angles of the normal n of the opening system.

The orientations of the opening directions of the “grain boundary” blocks may be represented by a pole figure reproduced in FIG. 5, in which the seven orientations are marked 1, 2, 3, 4, 5, 6 and 7.

The volume fractions of the “grain boundary” blocks are chosen in such a manner that their total volume fraction is equal to six times the ratio of the mechanical thickness of the grain boundary to its diameter. By way of example, this represents a few percent.

In order to describe the behaviour of the grain boundaries, conventional viscoplastic models which enable the opening rates of the grain boundaries to be determined are used. These models are, for example, the models described by Onck and Van der Giessen in Journal of the Mechanics and Physics of Solids—Vol 47, 1999, pages 99-139—“Growth of an initially sharp crack by grain boundary cavitation”.

A “hole” block which is to model ductile damage will now be described. Such a “hole” block is characterized by a pure-volume plastic deformation rate represented by the equations:

$${\dot{ɛ}}_{m}^{p} = 1 / 3 {D}_{1} exp [ \frac{{Σ}_{m}}{{ρσ}_{1}} ] {\dot{E}}_{eq}^{p}$$

$$ρ = exp ( - 3 {E}_{m}^{p} )$$

$${\dot{E}}_{m}^{p} = f {\dot{ɛ}}_{m}^{p}$$

$$f = 1 - ( 1 - {f}_{0} ) exp ( - 3 {E}_{m}^{p} )$$

in which:
D₁ and σ₁ are characteristic scalar coefficients of the material,
\dot{ε}ₘ^{p} is the microscopic volume plastic strain rate.
Σₘ is the mean macroscopic stress, equal to ⅓ of the trace of the stresses tensor.
\dot{E}_{eq}^{P} is the von Mises equivalent macroscopic plastic strain rate.
\dot{E}ₘ^{p} is the mean macroscopic plastic strain rate.
f₀ is the initial volume fraction of the “hole” block.
f is the volume fraction of the “hole” block at the instant t.
ρ is the relative volume mass.

This “hole” block has a volume fraction f which is a variable. When a “hole” block is added to a model composed of “grain” blocks each having a volume fraction f_{g}, it is considered that the volume fraction of each “grain” block becomes (1−f) f_{g}.

The different “grain”, “grain boundary” and “hole” blocks which have just been described enable the microscopic behaviour of the material to be modelled. However, as has been seen above for modelling the behaviour of an object, it is necessary to be able to pass from the microscopic level to the macroscopic level and vice versa. In order to do that, models called “scale change models” are used, the general principle of which is known by the person skilled in the art but which, in the context of the present invention, include distinctive characteristics which will now be described.

Three situations will be considered according to whether the model comprises only “grain” blocks, the model comprises “grain” blocks and “grain boundary” blocks or the model comprises “grain” blocks and a “hole” block.

When the model comprises only “grain” blocks, the relationships permitting passage from the macroscopic scale to the microscopic scale and vice versa are, respectively:
a) for passage from the macroscopic scale to the microscopic scale:
σ_{g}=Σ+2μ(1−β)α(E^{P}−ε_{g}^{P})

$$with \text{:}$$

$$\frac{1}{α} = 1 + {D ( {{E}_{=}}^{p} )}_{eq}^{max}$$

$$and$$

$$β = \frac{2}{15} \frac{4 - 5 v}{1 - v}$$

In those equations,

σ_{g} is the tensor of the microscopic stresses in the “grain” block of index g.

Σ is the tensor of the macroscopic stresses.

E^{P} is the tensor of the macroscopic plastic strain.

ε_{g}^{P} is the tensor of the microscopic strain in the “grain” block of index g.

μ is the shear modulus of the material.

v is the Poisson coefficient of the material.

D is a parameter which is peculiar to the material and which is adjustable on the basis of tests.

(E^{P})_{eq}^{max} is the maximum value, achieved beforehand, of the second von Mises invariant of the macroscopic plastic strain tensor.
b) For passage from the microscopic scale to the macroscopic scale:

$${Σ}_{=} = {\sum }_{g = 1}^{N} ( {f}_{g} {σ}_{= g} )$$

$${E}_{= p} = {\sum }_{g = 1}^{N} ( {f}_{g} {{ɛ}^{P}}_{= g} )$$

$${\dot{E}}_{= p} = {\sum }_{g = 1}^{N} ( {f}_{g} {{ɛ}^{P}}_{= g} )$$

$${{E}_{=}}^{e} = \frac{1}{2 μ} \{ {1}_{{=}_{=}} - \{ \frac{v}{1 + v} {1}_{=} ⊗ {1}_{=} \} \} : {Σ}_{=}$$

in those equations,

f_{g} is the volume fraction of the “grain” block of index g,

E^{e} is the macroscopic elastic strain tensor.

When the model comprises “grain” blocks and “grain boundary” blocks, the relationships of passage from the macroscopic level to the microscopic level and of passage from the microscopic level to the macroscopic level are modified in the following manner:

$${σ}_{= g} = {Σ}_{=} + 2 μ ( 1 - β ) [ η ( {1}_{=} ⊗ {1}_{=} ) + α {1}_{{=}_{=}} ] ( {{E}_{=}}^{p} - {{ɛ}_{= g}}^{p} )$$

$$with$$

$$\frac{1}{α} = 1 + {D ( {{E}_{=}}^{p} )}_{eq}^{max}$$

$$and$$

$$\frac{1}{η} = 2 + 5 {D ( {{E}_{=}}^{p} )}_{eq}^{max}$$

Finally, when the model comprises “grain” blocks and a “hole” block, the relationships of passage from the macroscopic level to the microscopic level and vice versa are the following:
a) for passage from the macroscopic scale to the microscopic scale

$${{σ}_{\underline{\_}}}_{g} = \frac{1}{1 - f} {Σ}_{\underline{\_}} + {D}_{1} f {σ}_{1} exp [ \frac{{Σ}_{m}}{{ρσ}_{1}} ] \frac{{Σ}_{\underline{\_}}}{{Σ}_{eq}} + 2 μ ( 1 - β ) α ( {\sum }_{h = 1}^{N} ( {f}_{h} {{ɛ}_{h}^{p}}_{\underline{\_}} ) - {{ɛ}_{g}^{p}}_{\underline{\_}} )$$

$$and$$

$${{σ}_{\underline{\_}}}_{0} = - ( 1 - f ) {D}_{1} {σ}_{1} exp [ \frac{{Σ}_{m}}{{ρσ}_{1}} ] \frac{{Σ}_{\underline{\_}}}{{Σ}_{eq}}$$

σ₀ is the tensor of the microscopic stresses in the “hole” block.

D₁ and σ₁ are parameters peculiar to the material.
b) and for passage from the microscopic scale to the macroscopic scale:

$${Σ}_{\underline{\_}} = f {{σ}_{\underline{\_}}}_{0} + ( 1 - f ) {\sum }_{g = 1}^{n} ( {f}_{g} {{σ}_{\underline{\_}}}_{g} )$$

$${{\dot{E}}_{\underline{\_}}}^{p} = f {\dot{ɛ}}_{m}^{p} {1}_{\underline{\_}} + ( 1 - f ) {\sum }_{g = 1}^{N} ( {f}_{g} {{\dot{ɛ}}_{\underline{\_}}}_{g}^{p} )$$

$${{\dot{ɛ}}_{\underline{\_}}}_{g}^{p} = {Σ}_{s} ( {{m}_{\underline{\_}}}_{s}^{g} ) {\dot{Υ}}_{s}^{g}$$

The blocks as defined hereinbefore, associated with the localization models which have just been described, constitute the polycrystalline model. This model enables the effect of mechanical stresses on an object to be calculated, but for that purpose it must be integrated in a finite element calculation model.

The integration of the polycrystalline material behaviour model in a finite element calculation model will now be described.

First of all, the case of a calculation without damage, that is to say, in which the behaviour model comprises only “grain” blocks, will be described. In such a model, since the number of “grain” blocks is small, a single “grain” block is assigned to each discretization point of the finite element structure calculation. The “grain” blocks are assigned to the Gauss points, which are the points of integration in the finite element calculation. At each of these points, since the number of “grain” blocks is equal to one, only the scalar relationships of the behaviour of the “grain” blocks are used. Furthermore, the macroscopic plastic strain rates are mixed up with those of the “grain” blocks. The same applies to the macroscopic stress which is equal to the stress in the “grain” block, and to the macroscopic strain which is equal to the strain in the “grain” block. The result is that the localization and homogenization relationships of the scale change model become useless.

In order to provide a good representation of the structure of the material and, in particular, its homogeneity in space, the “grain” blocks are assigned to the integration points of the lattice of the structure by means of an algorithm ensuring permutation within the same finite element and between the neighbouring finite elements. Thus, the “grain” blocks are distributed in a manner analogous to the grains of the real material. An example of distribution is given in FIG. 6 which corresponds to the case of a material having a cubic structure such as described above. That Figure represents a finite element indicated generally by 10 and comprising six quadrilateral faces. The peaks and the centres of the edges correspond to nodes of the model which are marked 11, which makes twenty nodes. The integration points or Gauss points, marked 12, are located inside the finite element. The “grain” blocks corresponding to the seven orientations are distributed as indicated by the numbers 1 to 7 associated with the Gauss points. In the case where the object studied is a plate or a body, that object is represented by several layers of identical thickness with three integration points in the middle and at the limit of each layer, which leads to a number of integration points equal to 2 p+1. As from three to five layers are used, the number of integration points is seven, nine, or eleven. Thus, the plate or the body comprises all of the “grain” blocks of the model in its thickness, like a real material. Permutation ensures a good representation of the real material in the directions tangent to the plate or to the body. Permutation also ensures a good average representation of the real material in the thickness of the plate or the body. The distribution of the “grain” blocks is represented in FIG. 7. The finite element 20 comprises three layers 21, 22 and 23. The integration points are grouped into four sets 24, 25, 26 and 27 each comprising seven “grain” blocks whose orientations are marked from 1 to 7. In some cases, it may be advantageous to assign several “grain” blocks to one of the integration points or even all of the “grain” blocks of the model to each integration point. In that case, the calculations are a little longer.

In particular, in the finite element calculation with texture evolution using the ten “grain” blocks defined above for an initially isotropic material, two “grain” blocks corresponding to the dissociated grains 1 and 8, 2 and 9, 3 and 10 are assigned to specific integration points. If use is made of the ten additional “grain” blocks obtained by substituting the normals to the slip planes nₛ and the slip directions lₛ, these blocks are assigned to the same integration points as the blocks 1 to 10. The number of distinct behaviours of the integration points thus remains limited to seven, as in the case of a calculation without texture evolution for an isotropic material.

When the case in which the boundaries may be damaged is considered, that is to say, when a model comprising “grain boundary” blocks is used, since the volume fractions of the “grain boundary” blocks are very small, in order to obtain a good representation of the material, a “grain” block and a “grain boundary” block are associated with each integration point of the finite element calculation model, and a permutation algorithm is used such that the “grain” block/“grain boundary” block couples are not always the same. In that case, the scale change relationships remain necessary but are very simplified.

These relationships are:

$${Σ}_{\underline{\_}} = {f}_{g} {{σ}_{\underline{\_}}}_{g} + {f}_{j} {{σ}_{\underline{\_}}}_{j}$$

$${{E}_{\underline{\_}}}^{p} = {f}_{g} {{ɛ}_{\underline{\_}}}_{g}^{p} + {f}_{j} {{ɛ}_{\underline{\_}}}_{j}^{p}$$

$${f}_{g} + {f}_{j} = 1$$

$${{σ}_{\underline{\_}}}_{g} = {Σ}_{\underline{\_}} + 2 μ ( 1 - β ) [ η ( {1}_{\underline{\_}} ⊗ {1}_{\underline{\_}} ) + α {1}_{{=}_{=}} ] {f}_{j} ( {{ɛ}_{\underline{\_}}}_{j}^{P} - {{ɛ}_{\underline{\_}}}_{g}^{p} )$$

$${{σ}_{\underline{\_}}}_{j} = {Σ}_{\underline{\_}} + 2 μ ( 1 - β ) [ η ( {1}_{\underline{\_}} ⊗ {1}_{\underline{\_}} ) + α {1}_{{=}_{=}} ] {f}_{g} ( {{ɛ}_{\underline{\_}}}_{g}^{p} - {{ɛ}_{\underline{\_}}}_{j}^{p} )$$

In the case where it is desired to model ductile damage, that is to say, when a model comprising “grain” blocks and a “hole” block is used, a “grain” block and a “hole” block are associated with each of the integration points. Also in that case, the localization relationships are very simplified and these relationships are:

$${{\dot{E}}_{\underline{\_}}}_{dev}^{P} = ( 1 - f ) {\dot{{ɛ}_{\underline{\_}}}}_{g}^{P}$$

$${{\dot{E}}_{\underline{\_}}}_{m}^{P} = f {\dot{{ɛ}_{\underline{\_}}}}_{0 m}^{P}$$

$${{σ}_{\underline{\_}}}_{g} = \frac{1}{1 - f} {Σ}_{\underline{\_}} + {D}_{1} ρ {σ}_{1} exp ( \frac{{Σ}_{m}}{{ρσ}_{1}} ) \frac{{Σ}_{\underline{\_}}}{{Σ}_{eq}}$$

With this model, it is therefore possible to calculate the evolution, between an instant 0 and an instant t, of the properties of the material constituting the object in respect of which the strains and deformation in the macroscopic state are being studied. However, in order to carry out such a calculation, it is necessary to be able to determine the different parameters involved in the model.

In order to determine those parameters, an identification method known per se, according to which results of tension tests, tension/torsion tests or also other mechanical tests, such as creep tests, are first of all collected in a database relating to the material. Then the various tests of the database are simulated by calculation using a priori values of the parameters. Then the results of these simulations are compared with the tests proper and new values for the parameters are derived as a function of the difference between the experimental results and the calculated results. Finally, this process is reproduced until the differences between the experimental results and the simulated results are less than a value defined in advance.

By way of example, the model according to the invention was applied to the case of a tube composed of recrystallized zircaloy subjected to a biaxial tensile force. Cylindrical coordinates were used in the laboratory coordinate system (L₁, L₂, L₃).

The model was identified on the basis of two tension tests in the axial zz and tangential θθ orientations of the tube, and a torsion test zθ on the tube. The result of the identification is represented in FIG. 9. In that Figure, the triangles marked 31 correspond to experimental points, the curve 32 represents the results as obtained by applying the von Mises criteria with a conventional macroscopic material behaviour model, the curve 33 represents the results obtained by a polycrystalline model according to the prior art, and the curve 34 represents the results obtained with the model according to the invention. These curves show that the method according to the invention leads to very good agreement between the experimental results and the calculated results for tensions in all of the directions of the plane zz-θθ, which is not the case of the simple application of the von Mises criteria, nor the case of the use of a polycrystalline model according to the prior art. The identification required 2 hours' calculation at a standard calculation station. The identification of the polycrystalline model according to the prior art is described in “Philippe Geyer, Comportement élasto-viscoplastique de tubes en Zircaloy-4: approche expérimentale et modélisation micromécanique, thèse de l'Ecole des Mines de Paris, 9 décembre 1999” (Philippe Geyer, Elasto-viscoplastic behaviour of zircaloy-4 tubes: experimental approach and micromechanical modelling, thesis of the Ecole des Mines de Paris, 9 Dec. 1999). This identification required several days' calculation on a set of 5 to 10 calculation stations working simultaneously. The result is not as good as with the model according to the invention, not because the polycrystalline model according to the prior art is not as good as the model according to the invention, but because it leads to very long calculations which prevent the identification of the parameters from being optimized. This example shows the value of the method according to the invention which reduces the calculation times considerably and thus enables the effect of mechanical stresses on objects to be determined under conditions in which the methods according to the prior art are not applicable.

The method just described enables the evolution of the properties of the material and also the damage thereto to be calculated. It requires viscoplastic models but the person skilled in the art will be able to use any inelastic behaviour model compatible with a polycrystalline model according to the invention and, in particular, creep behaviour and fatigue-creep behaviour.

The damage corresponds either to the opening of the “grain boundary” blocks or to the enlargement of the “hole” blocks depending on whether interest is in intergranular damage or ductile damage. In both cases, the person skilled in the art can define a defined rupture criterion, for example, by a damage threshold such that, beyond it, rupture occurs. It is thus possible to predict the conditions of rupture in service. In the case of intergranular damage, in the context of a finite element method, it is possible to define an opening criterion of a “grain boundary” block such that, when this criterion is met, cracking occurs and, at the corresponding point, the mechanical strength is zero. In the case of ductile damage, in the context of a finite element method, it is possible to define a critical volume fraction of a “hole” block such that, when that criterion is met, cracking occurs and, at the corresponding point, the mechanical strength is zero. In the calculations, the point at which the criterion is reached first is considered. Then, by taking into account the neighbouring points to which the strains will be transferred, it is possible to follow the growth of the crack and thus to determine the conditions of the occurrence of rupture.

The method according to the invention can be used to determine the effect of the method of manufacturing an object comprising a shaping operation by cold plastic deformation, such as pressing, and in particular to determine the mechanical properties of the object at each of its points. For, the effect of a shaping operation by plastic deformation on mechanical properties depends on the deformation actually produced and this deformation depends in general on the point considered. The mechanical properties after shaping are therefore not, in general, identical at all points in the object. It is then possible to use the estimate of the distribution of the mechanical properties of the object, which is obtained by the method according to the invention, to determine the behaviour in service of that object. The advantage of the method according to the invention is that this estimate of the distribution of the mechanical properties of an object can be carried out under very diverse conditions on the basis of a limited number of mechanical tests. For, in order to estimate the mechanical properties of objects composed of the same material but produced by shaping in accordance with different modalities, it is sufficient to carry out the mechanical tests necessary for the construction of the polycrystalline model according to the invention, which is representative of the material, then to apply the method according to the invention to each of the particular cases envisaged.

By way of example, the method according to the invention can be used to evaluate the impact behaviour of a motor vehicle workpiece obtained by pressing or by bending or by any other shaping process bringing about plastic deformation. For that purpose, the polycrystalline model representative of the material of which the workpiece is composed is constructed. The polycrystalline model is set using the necessary mechanical tension or tension/torsion or shear tests. Then, using a calculation method such as a finite element calculation method, incorporating the polycrystalline model representative of the material, the shaping operation is simulated and the mechanical properties of the workpiece are determined at each of its points. On the basis of this result and using a suitable calculation method known by the person skilled in the art, for example, the effects on the workpieces of an impact resulting from a collision are determined.

When it is desired to determine the behaviour in service of various workpieces produced from the same material, the same polycrystalline model representative of the material is used to carry out the behaviour simulation calculations. Thus, there is no purpose in carrying out mechanical tests for each workpiece.

The method according to the invention can also be used to determine the behaviour of a workpiece composed of a material which may have a phase transformation, that is to say, a change in crystallographic structure under the effect of the thermomechanical stresses which it undergoes under the service or shaping conditions considered.

This is the case, for example, of an isotropic shape-memory alloy which has two phases, the one stable at high temperature (austenite) and the other metastable at low temperature (martensite). A decrease in temperature and/or the application of mechanical stress brings about a progressive passage from austenite towards martensite. The opposite transformation is possible in a reversible manner. This phase transformation is accompanied by inelastic deformation which is added to the deformation proper of each phase taken independently.

The simulation of this phase transformation is carried out using “grain” blocks (7 in the case in point for an isotropic material), each being orientated in the macroscopic local coordinate system (X1, X2, X3) by its Euler angles Ψ, φ and φ. The behaviour of each block is simulated by the six slip systems described above and by their work-hardening laws known from another source. The parameters of these laws of behaviour correspond first of all to those of austenite.

In the course of thermomechanical loading, as a function of a criterion which is well defined and known, for example, from “Leclercq S., Lexcellent C, A general macroscopic description of thermomechanical behaviour of shape memory alloys, J. Mech. Phys. Solids, Volume 44, pp 953-980, 1996”, austenite is capable of being converted into martensite at a given rate. At each stage of the calculation, a check is carried out to establish whether this criterion is met, and the “grain” blocks for which the criterion is met are allocated the mechanical characteristics of martensite (evolution of the parameters of the behaviour laws of the slip systems of martensite, which is known from another source). The phase transformation deformation resulting from this evolution then occurs when the scale transition rules of the model are applied.

The model just described is basically a numerical model which can be implemented by any appropriate means, in particular, by a computer by integrating it in a finite element calculation code known per se.

This model can be used in the same manner in any structure deformation calculation method and, in particular, in finite difference calculation methods or in methods which involve only one point in the object studied, as is the case in the modelling of the rolling of flat products. The person skilled in the art knows how to make the necessary adaptations, which concern only the integration of the model in the calculation method.

The examples of application to materials having cubic or hexagonal crystallographic structures have been described. However, the invention is not limited to these examples and the person skilled in the art will know how to apply it to other crystal structures and to various textures. The invention can also be applied to mixed structures composed of crystals of different natures. For that purpose, it is sufficient to take into account “grain” blocks of which one portion corresponds to one crystal structure and another portion corresponds to another crystal structure.

To summarize, the method according to the invention, applied to an object composed of a given material and subjected for a predetermined period of time to predetermined mechanical and optionally thermal stresses, consists in:
choosing a behaviour model of the polycrystalline type according to the invention, suitable for the material,
adjusting the parameters of the behaviour model on the basis of a limited number of suitably chosen mechanical tests,
identifying the effect of the mechanical and optionally thermal stresses to which the object is subjected for the period of time considered,
and calculating the effect of the stresses at each point in the object using a calculation method incorporating the behaviour model of the material.

The method can be applied to any type of material whose behaviour can be represented by a model of the polycrystalline type, and in particular to any metal material.

The stresses to which the object is subjected, which may be forces or displacements distributed in space and in time and which may be completed by thermal stresses, can be determined by any means and in particular by recording measurements.

The calculation methods used by the method are numerical calculation methods implemented by computers with the aid of suitable software.

1. Method for determining the effects of mechanical stress on an object composed of a solid material, according to which method the strains and stresses generated by the mechanical stress at a plurality of points in the object are calculated by means of a numerical calculation method in inelastic mode, in which the behaviour of the solid material is represented by a polycrystalline microscopic behaviour model using a plurality of “grain” blocks whose strains is determined on the basis of a plurality of slip systems peculiar to the solid material, the trace of the tensor of the microscopic strains being zero, each “grain” block having an orientation and a volume fraction, characterized in that:
the number of “grain” blocks is less than or equal to ten,
the number of slip systems is less than or equal to six,
in addition, the microscopic model optionally uses:
up to seven “grain boundary” blocks which each have an orientation and a volume fraction and whose deformation is determined on the basis of at least one opening system, the trace of the tensor of the microscopic plastic strains of each “grain boundary” block being positive,
at most one “hole” block which has a variable volume fraction and whose plastic deformation is purely in volume and whose microscopic plastic strains tensor trace is positive.

2. Method according to claim 1, characterized in that the six slip systems associated with a “grain” block and defined in an orthonormal coordinate system associated with the “grain” block by the normals to the slip planes and by the slip directions are such that the twin of the orientation matrix associated with each slip system is constituted only by 0, 1 or −1.

3. Method according to claim 1, characterized in that, for an isotropic material having a cubic structure, the deformation is determined on the basis of two families of three slip systems, a first family corresponding to the faces of the cube, and the second family corresponding to the planes at 45° to those faces, and in that the number of “grain” blocks is equal to seven, the “grain” blocks being obtained by symmetrization of two primitive “grain” blocks located on the 45° great circles of the pole figure.

4. Method according to claim 1, characterized in that the evolution of the texture of the material is also determined by calculating the rotation Q of the crystal lattice of each “grain” block relative to a corotational coordinate system.

5. Method according to claim 4, characterized in that, for an isotropic material having a cubic structure, the number of “grain” blocks is equal to ten.

6. Method according to claim 1, characterized in that the progress of a phase transformation is also determined.

7. Method according to claim 6, characterized in that characteristics that are a function of the progress of the phase transformation are allocated to each “grain” block.

8. Method according to claim 1, characterized in that the orientations and the volume fractions of the “grain” blocks are determined by adjustment on the basis of biaxial tension tests and tension-torsion tests.

9. Method according to claim 1, characterized in that, in the absence of a “hole” block, the model for passing from the macroscopic level to the microscopic level for a “grain” block, which permits calculation of the tensor of the microscopic stresses σ_{g} in the “grain” block as a function of the tensor of the macroscopic stresses Σ, of the tensor ε_{g}^{P} of the microscopic plastic strains in the “grain” block and of the tensor E^{P} of the macroscopic plastic strains, is written:
σ_{g}=Σ+2μ(1−β)[η(1\textcircled{x}1)+α1](E^{P}−ε_{g}^{P})
with, 1/α=1+DE_{eq}^{max}, and 1/η=2+5E_{eq}^{max}, E_{eq}^{max} is the maximum value reached by the second von Mises invariant during deformation.

10. Method according to claim 1, characterized in that the numerical calculation method is a finite element calculation method and in that a single “grain” block and optionally a “grain boundary” block or a “hole” block is (are) associated with each integration point of the finite element calculation method in such a manner that the distribution of the blocks is homogeneous.

11. Method according to claim 1, characterized in that the numerical calculation method is a mechanical or thermo-mechanical calculation method involving time.

12. Method according to claim 11, characterized in that a “hole” block is used and in that the volume fraction of the “hole” block is not zero at the initial instant of the numerical calculation.

13. Method according to claim 1, characterized in that the number of “grain boundary” blocks is greater than or equal to one, and in that a criterion is defined such that, when the criterion is met at one point in the object, a zero mechanical strength of the material is allocated to the point considered in order to simulate the presence of a crack.

14. Method according to claim 10, characterized in that a “hole” block is used, and in that a criterion is defined such that, when the criterion is met at one point in the object, a zero mechanical strength of the material is allocated to the point considered in order to simulate the presence of a crack.

15. Method according to claim 1, characterized in that the object of solid material is a metal workpiece, and in that the mechanical stress is the mechanical stress associated with a shaping operation by plastic deformation, such as, in particular, pressing, drawing, rolling, bending or forging.

16. Method according to claim 1, characterized in that the object of solid material is a metal workpiece, and in that the mechanical stress is a mechanical stress corresponding to the use of the metal workpiece.

17. Method according to claim 16, characterized in that the use in service of the workpiece generates at least one phenomenon from among the phenomena of creep, fatigue and fatigue-creep.
